(19) United States
(12) Patent Application Publication
(10) Pub. No.: US 2006/0195402 A1
(43) Pub. Date: Aug. 31, 2006

(54) Secure data transmission using undiscoverable or black data

(75) Inventors: Richard Malina, Mequon, WI (US); William Cochran, Champaign, IL (US)

Correspondence Address: MICHAEL BEST & FRIEDRICH, LLP, 100 E WISCONSIN AVENUE, MILWAUKEE, WI, 53202, US

(73) Assignee: Imagineer Software, Inc., Milwaukee, WI (US)

(21) Appl. No.: 11/368,959

(22) Filed: Mar. 6, 2006

Related U.S. Application Data
(63) Continuation-in-part of application No. 11/286,890, filed on Nov. 23, 2005.
Application No. 11/286,890 is a continuation-in-part of application No. 10/854,604, filed on May 26, 2004.
Application No. 10/854,604 is a continuation-in-part of application No. 10/248,894, filed on Feb. 27, 2003, now Pat. No. 6,996,544.
(60) Provisional application No. 60/360,023, filed on Feb. 27, 2002.

(51) Int. Cl. G06Q 99/00

(52) U.S. Cl. 705/50

(57) ABSTRACT

Methods and systems of encrypting data. One method includes establishing data that includes discoverable or “white” data and undiscoverable or “black” data. Black data is generally unrecognizable. For example, it may be random data. White data generally has recognizable content or is transmitted in a recognizable format. A first key and a second key are created or established, such that the second key is substantially underivable from the first key. The discoverable or white data is encrypted with the first key and the undiscoverable or black data is encrypted with the second key. In subsequent communications or transactions, at least one of the first key and the second key is mutated.

### RELATED APPLICATIONS

This application is a continuation-in-part of U.S. patent application Ser. No. 11/286,890 filed on Nov. 23, 2005, which is a continuation-in-part of U.S. patent application Ser. No. 10/854,604 filed on May 26, 2004, which is a continuation-in-part of U.S. patent application Ser. No. 10/248,894 filed on Feb. 27, 2003, which claims priority to U.S. Provisional Patent Application Ser. No. 60/360,023 filed on Feb. 27, 2002, the entire contents of which are all hereby incorporated by reference.

### BACKGROUND OF THE INVENTION

Encryption techniques provide a mechanism for disguising data (i.e., plaintext or unencrypted data) such that the data cannot be obtained without proper validation or authentication (e.g., possessing a key). Generally, encryption or encipherment processes apply an encryption key to plaintext data in order to generate ciphertext. To obtain the plaintext data out of the ciphertext, a decryption key is applied to the ciphertext to convert the ciphertext back to plaintext. Different types of keys can be used to generate and decrypt ciphertext. For example, symmetric key systems use a single key to perform both encryption and decryption (i.e., the encryption key equals the decryption key), and public/private key systems use a separate encryption key and decryption key. Public/private key systems obtain their name from the fact that the decryption key (i.e., the private key) is kept secret or private, and the encryption key (i.e., the public key) is generally publicly available. The security of public/private key systems lies in keeping the decryption key secret and ensuring that the decryption key is not easily calculated from the public encryption key.

Cryptanalysis is the science of recovering plaintext without the appropriate validation or authentication (e.g., without possessing a key). Attempted cryptanalysis is often called an attack. Various attacks can be performed to circumvent the security of encryption techniques. For example, a ciphertext-only attack can be performed when an eavesdropper obtains or steals ciphertext and attempts to determine the plaintext and/or the key used to generate the ciphertext. If an eavesdropper obtains the plaintext in addition to obtaining the corresponding ciphertext, he or she can perform a plaintext attack and can attempt to determine the key used to generate the ciphertext. Even if the eavesdropper can obtain only a portion of the plaintext or a known format of the plaintext in addition to obtaining the corresponding ciphertext, he or she might still be able to determine the key used to generate the plaintext. In most situations, the more information an eavesdropper can obtain the easier he or she can determine a key. Once an eavesdropper has determined a key, the eavesdropper can use the key to decrypt ciphertext.

### SUMMARY OF THE INVENTION

One embodiment of the invention provides a method of encrypting data. The method includes establishing data that includes discoverable or “white” data and undiscoverable or “black” data. Black data is generally unrecognizable. For example, it may be random data. White data generally has recognizable content or is transmitted in a recognizable format. The method also includes establishing a first key and a second key, where the second key is substantially underivable from the first key. The discoverable or white data is encrypted with the first key and the undiscoverable or black data is encrypted with the second key. In subsequent communications or transactions, at least one of the first key and the second key is mutated.

In another embodiment, messages are transmitted between an entity and an authenticator by establishing an identifier associated with the entity; establishing a first key to encrypt black data, where the first key is known only to the entity and the authenticator. A second key to encrypt white data is established. The second key is known only to the entity and the authenticator. A request identifier is established and encrypted with the second key to create an encrypted request. A hash of the request identifier is generated and the hash is encrypted with the first key to create an encrypted request hash. The encrypted request and the encrypted request hash are sent to the authenticator, and at least one of the first key and the second key is mutated.

In another embodiment, a system for encrypting data that includes discoverable data and undiscoverable data is provided. The system includes a sender having a first key and a second key. The second key is substantially underivable from the first key. The sender is configured to encrypt the discoverable data with the first key, to encrypt the undiscoverable data with the second key, and to receive at least one of a mutated first key and a mutated second key from an authenticator.

Other embodiments and details are illustrated and described in the drawings and detailed description.

### BRIEF DESCRIPTION OF THE DRAWINGS

In the drawings:

FIG. 1 schematically illustrates a system for transmitting data according to one embodiment of the invention.

FIG. 2 illustrates a bit stream (called a “mutating ID”) according to one embodiment of the invention.

FIGS. 3A and 3B illustrate ways of distributing mutating IDs.

FIG. 4 illustrates an exemplary brute force attack.

FIG. 5 illustrates types of data included in data to be encrypted.

FIGS. 6 and 7 illustrate an encryption strategy for protecting the security of undiscoverable or “black” data according to one embodiment of the invention.

FIGS. 8, 9, and 10 illustrate key extraction and mutation protocols according to various embodiments of the invention.

FIG. 11 illustrates a separate encryption protocol for communicating with an authenticator device according to one embodiment of the invention.

### DETAILED DESCRIPTION

Before embodiments of the invention are explained in detail, it is to be understood that the invention is not limited in its application to the details of the construction and the arrangements of the components set forth in the following description or illustrated in the drawings. The invention is capable of still other embodiments and of being practiced or being carried out in various ways. Also, it is to be understood that the phraseology and terminology used herein is for the purpose of description and should not be regarded as limiting.

In particular, it should be understood that some embodiments are implemented using various computer devices, such as personal or home computers, servers, and other devices that have processors or that are capable of executing programs or sets of instructions, including special purpose devices such as set top boxes (e.g., digital cable or satellite decoders). In general, some embodiments may be implemented using existing hardware or hardware that could be readily created by those of ordinary skill in the art. Thus, the architecture of exemplary devices will not be explained in detail, except to note that the devices will generally have a processor, memory (of some kind), and input and output devices. In some cases, the devices may also have operating systems and application programs that are managed by the operating systems. In some embodiments, the hardware devices or software executed by the hardware devices also provides some ability, depending on the role of the device in the particular embodiment of the invention implemented, to compress or decompress data or to encode data or decode encrypted data. In some instances, a decompression capability may be provided using available codecs, such as hardware-implemented Moving Picture Experts Group (“MPEG”) codecs. A decryption capability may be provided using a decryption hardware or software module capable of decrypting data that is encrypted using a particular encryption algorithm. In some embodiments, the encryption algorithm includes the Rijndael algorithm, an example of which is available at http://www.esat.kuleuven.ac.be/˜rijmen/rijndael/rijndaelref.zip.

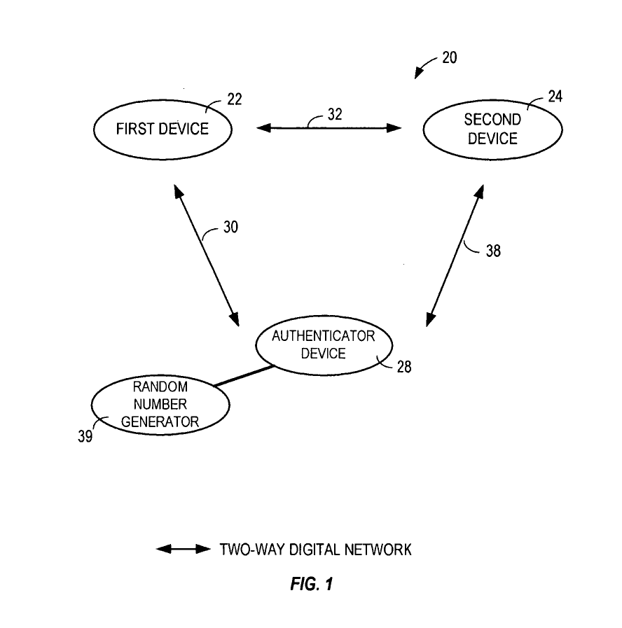

FIG. 1 illustrates an exemplary system 20 configured to distribute content over a network. In reality, one or more networks or communication systems such as the Internet, the telephone system, wireless networks, satellite networks, cable TV networks, and various other private and public networks could be used in various combinations to provide the communication links desired or needed to create embodiments or implementations of the invention, as would be apparent to one of ordinary skill in the art. Thus, the invention is not limited to any specific network or combinations of networks. However, in some embodiments, the networks or communication systems used in the system 20 have the ability to support digital and/or secure communications, such as communications with data encrypted with a version of Rijndael encryption or others. Furthermore, data can be transferred from one entity to another with wired communications, wireless communications, or physical media being physically carried from one entity to another.

In the embodiment shown in FIG. 1, the system 20 includes three participants: a first device 22, a second device 24, and an authenticator device 28. In the exemplary embodiment illustrated in FIG. 1, it is assumed that the first device 22 possesses data to be transmitted to the second device. Although FIG. 1 only illustrates the first device 22 and the second device 24, in some embodiments, numerous devices are included in the system 20, where at least one of the devices possesses data to be transmitted to another device. Furthermore, in some embodiments, the system 20 includes multiple authenticator devices 28.

The first device 22, the second device 24, and the authenticator device 28 are connected to each other via two-way links 30, 32, and 38. The links 30, 32, and 38 can include all or part of one or more of the networks mentioned above. In some embodiments, the system 20 uses a key-based encryption algorithm and currently available algorithms, such as the Rijndael algorithm. Choices for the algorithms used in the system 20 can depend on a variety of factors including a trade off between the strength of the algorithm (in terms of being broken) and speed (in terms of a processor's capability to perform the mathematical operations required by the chosen algorithm).

In some embodiments, as shown in FIG. 1, the authenticator device 28 uses a random number generator 39 to generate numbers used by a protocol implemented or followed by the system 20. The random number generator 39 can produce numbers that are as truly random (i.e., numbers that are as random as is possible with the particular technology used to implement the invention). For example, communication traffic, such as requests from customers to obtain content, can be used to create random numbers. Such requests occur, in general, in an unpredictable manner. Thus, the random numbers generated based on such traffic are also truly or nearly truly random, as opposed to pseudo random numbers generated with algorithmic methods.

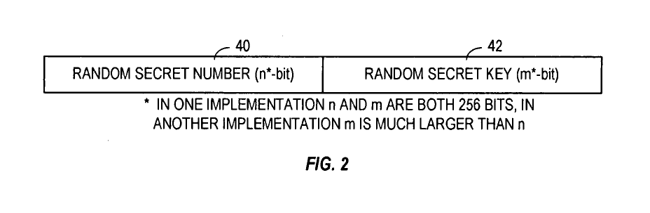

In some embodiments, the first device 22 and the second device 24 use mutating identifiers (“IDs”) to transmit data. An exemplary mutating ID 38 is shown in FIG. 2. The mutating ID 38 is an identifier having two portions: a first portion 40 and a second portion 42. The first portion 40 includes an identifying number, which is a random number. As indicated in FIG. 2, in some embodiments, the two portions of a mutating ID each include a number of bits. For example, the first portion 40 and the second portion 42 can each include 256 bits. In other embodiments, the first portion 40 and/or the second portion 42 include a larger number of bits, such as 1 megabit or 1 megabyte.

The second portion 42 includes a secret key, which is also a random number and, in some embodiments, is a symmetric cipher key. A mutating ID can be used only once and then cannot be used again for a long time.

In addition, although FIG. 2 illustrates a mutating ID has having only two portions, a mutating ID can include additional sections or portions. For example, as described below, a mutating ID can include an identifying number, a secret key for a first type of data (e.g., discoverable data), and a secret key for a second type of data (e.g., undiscoverable data).

Mutating IDs are generated and tracked by the authenticator device 28. Because mutating IDs are one-time-use mechanisms, once the first device 22, the second device 24, or another device uses its supply of mutating IDs, (e.g., a single mutating ID or multiple single mutating IDs) the device can obtain another mutating ID (or multiple mutating IDs if applicable) from the authenticator device 28. The data included in a mutating ID can be chosen at random with an equal probability of all possible mutating IDs.

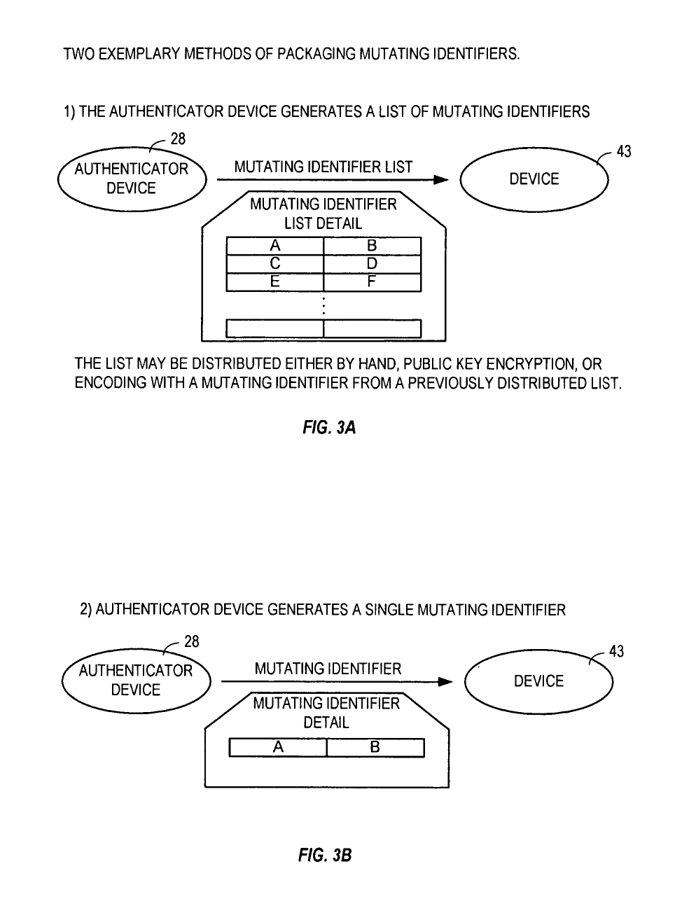

FIGS. 3a and 3b illustrate how mutating IDs can be distributed from the authenticator device 28 to the first device 22 or the second device 24. As shown in FIG. 3a, in some embodiments, a device 43 (such as the first device 22 or the second device 24) may request multiple mutating IDs from the authenticator device 28. The authenticator device 28 creates as many mutating IDs as the device 43 requests and sends a list of mutating IDs to the device 43. The device 43, knowing the quantity of mutating IDs requested and the size of each mutating ID, breaks the list into individual mutating IDs. In some embodiments, the authenticator device 28 provides information or instructions to the device 43 to assist the device 43 in separating the mutating IDs. For example, the authenticator device 28 can provide information or instructions to the device 43 to assist the device 43 in separating the mutating IDs using a data description language, such as extensible markup language (“XML”).

As shown in FIG. 3b, in other embodiments, a device 43 can receive a single mutating ID upon requesting a new mutating ID or upon using a previously provided mutating ID. The single, new mutating ID is sent to the device 43, which replaces the mutating ID previously provided to the device 43.

In the embodiment shown in FIG. 1, the authenticator device 28 randomly assigns or provides a mutating ID to the first device 22 (hereinafter referred to in this example as the “first mutating ID”) and a mutating ID to the second device 24 (hereinafter referred to in this example as the “second mutating ID”). The first mutating ID is different from the second mutating ID and each of the first mutating ID and the second mutating ID do not provide information for determining the other mutating ID. As described above with respect to FIG. 2, each mutating ID includes a random number 40 and a random corresponding secret key 42. In some embodiments, a mutating ID takes the form of a modified hash. As described above, in addition to being random, the mutating ID (or the hash if applicable) is discarded after each use. In other words, the authenticator device 28 provides a new mutating ID with a new random number and a new random secret key 42 after a mutating ID is used. In some embodiments, the mutating ID is completely unrelated from the device using it. That is, the mutating ID or the hash does not contain any information concerning the identity of the device. In this way, the identities of devices are blind to all participants except for the authenticator device 28.

Some embodiments of the invention implement symmetric key systems. Symmetric key systems commonly encounter key management issues as the number of entities or parties of the system grows. For example, a network of n entities requires n(n-1)/2 keys to enable all entities to communicate with one another. Thus, for a system of 1000 entities, where every entity wishes to send identical content to every other entity, almost a half million keys are required.

Disclosed embodiments, however, do not require a separate key for every pair of entities of the system. As will be illustrated, each entity and each piece of content distributed by each entity each receives one key, which is mutated after each use. Therefore, for a system of 1000 entities, only 2000 keys are required compared to the almost half of a million keys with previous symmetric key systems. Also, the authenticator device 28 is not required to store the entire bit string of the mutating ID. The authenticator device 28 may use a hash function or simply a positional index to map each key partition of the mutating ID into a memory storage location based on the corresponding number.

Other differences between embodiments of the invention and prior security systems relate to speed and reduced vulnerability to certain attacks. The use of symmetric keys also allows fast computation (as compared to public key systems). The fundamental concept behind public key systems is the use one-way functions. One-way functions are easy to compute but hard to reverse. Public key systems use trapdoor one-way functions that provide a key to compute the one-way function in the opposite direction. Public key systems provide public keys for each participant that are freely accessed and used as a one-way function to apply to a message. Public key systems also provide private keys (which are believed to be computationally infeasible to derive from the public key) to each individual participant to compute the message given the calculation of the one-way function. The security of public key systems relies on the assumption that the private key cannot be derived from the public key. In order to maintain this requirement, the one-way functions used in public key systems are complex. The added complexity, however, comes at the cost of added computation time. Public key systems are often 1000 times slower than symmetric key systems.

The use of symmetric keys also reduces the effectiveness of chosen plaintext attacks. A chosen-plaintext attack occurs when an intruder has access to an encryption key or process, chooses specific plaintext to encrypt, and attempts to gain knowledge from the encrypted text. In public-key systems an individual's public key is known to all participants in a communication system. Any intruder can encrypt an endless number of messages using an individual's public key. If an attacker encrypts possible messages with an individual's public key and then intercepts an encrypted message sent to the individual, the intruder can compare the intercepted message with messages he or she has created. If an interception message matches an encrypted message created by the intruder, the message has been compromised and the intruder can now read a message that was not intended for him or her. This attack is relatively easy and effective if a small number of possible messages exist, but even if the number of possible messages is more than the intruder is able to encrypt or compare with intercepted encrypted messages, just knowing that an intercepted encrypted message does not correspond to a particular message can provide useful information to the intruder. In either situation, the intruder will not be able to deduce the private key of the individual but the intruder may be able to deduce the message, or information regarding the message, sent to the individual. Since embodiments of the invention utilize a symmetric key system, chosen-plaintext attacks are not applicable because encryption keys are not public knowledge.

There is another problem with prior symmetric key systems and public key systems. Once an unauthorized entity gains access to an authorized key, the unauthorized entity can decode all messages encrypted with the compromised key, and, perhaps more dangerous, can encrypt false messages to deceive other entities of the system. The mutating ID protocol reduces this weakness by mutating each secret key after it has been used. Even if a secret key is compromised, the compromised secret key cannot be used to generate future messages nor be used to decrypt future messages since it is marked by the authenticator as used and is not used again to encrypt future messages.

The system 20 uses a protocol to govern communications between entities. Each entity is randomly assigned a mutating ID, such as the identifier or ID 38 shown in FIG. 2, by the authenticator device 28. As noted, each mutating ID includes a random number 40 and a random corresponding secret key 42. In some embodiments, a mutating ID takes the form of a modified hash.

The authenticator device 28 also generates encryption keys for content or data distributed through the system 20. A device wishing to transmit data requests a key from the authenticator device 28. The device sending the data (i.e., the sending device) supplies the authenticator device 28 with a label or function (i.e., any identifying string) of the data to transmit, and the authenticator device 28 responds with an associated key. The key, like the mutating IDs, is unrelated to the data that it encrypts. The authenticator device 28 also has no knowledge of the data since only an identifier (e.g., a random identifier) of the data is provided. The authenticator device 28 records the key and the associated identifier of the data.

In some embodiments, after the authenticator device 28 generates and supplies a key associated with the identifier of the data to the sending device, the sending device uses the key to encrypt the data. A device receiving the encrypted data (i.e., the receiving device) can request the corresponding decryption key (e.g., the same key used to encrypt the data) from the authenticator device 28. In some embodiments, the authenticator device 28 supplies a decryption key to any authorized receiving device included in the system 20 that makes a legitimate request. A request for a decryption key includes a reference to the label or identifying string of the data. The authenticator device 28 determines the associated key based on the label indicated in the request and returns the appropriate key to the receiving device.

Exemplary embodiments of the invention will now be described using several examples.

As with many descriptions of communication protocols, names are assigned to the various devices (or computer systems associated with those devices) used in the protocol. In one embodiment, Alice (A) and Bob (B) represent the first device 22 and the second device 24 respectively, and Trent (T) represents the authenticator device 28, a trusted arbiter of communication. Carol (C) can also represent a third device included in the system 20. The following table, Table 1, is a list of other symbols used in this document to explain multiple embodiments of the protocol.

TABLE 1

| Symbol | Meaning |
|---|---|
| A, B, C, T | Entities (e.g., devices) included in the system. |
| M | Data or content. |
| X_{id} | An identifier (e.g., public identifier) for an entity X. |
| X_{cred} | Secret information that identifies an entity X, which |
| | is known only to the entity X and the authenticator and is |
| | randomly assigned by the authenticator. |
| K_{X} | A key for a symmetric cipher associated with some |
| | entity X. |
| N_{X} | A one-use number associated with some key K_{X}. |
| H(X) | A function that produces a hash of X. |
| E(K, X) | A cipher that encrypts X with K. |
| X → Y: Z | A message Z sent from X to Y. |
| {(Nⁱ_{X}, Kⁱ_{X})} | A set of number/key pairs of arbitrary size |
| | associated with entity X. |
| XOR(Y, Z) | Bitwise exclusive or of Y and Z |

Session Keys

In some embodiments, mutating IDs are used to exchange a communication or session key between two entities. For example, assume that Alice and Bob would like to communicate securely. Again assume that Alice and Bob trust Trent and that Trent assigns Alice a mutating ID that includes a number N_{A} and a secret key K_{A} for some symmetric cipher and assigns Bob a mutating ID that includes a number N_{B} and a secret key K_{B} for some symmetric cipher. Also assume that Alice and Bob each have credentials (e.g., A_{cred} and B_{cred} respectively) that are known only to Trent and the holder of the credentials.

To request a session key K_{AB} from Trent, Alice encrypts her credentials and an identifier of Bob (e.g., B_{ID}) with her secret key K_{A} and appends her number N_{A} to the result. Alice sends the message to Bob.
A→B: N_{A}E(K_{A}, A_{cred}B_{id})

Bob concatenates his credentials and an identifier of Alice (e.g., A_{id}) with the message from Alice and encrypts the result with his secret key K_{B}. Bob appends his number K_{B} to the result of the encryption and sends the result to Trent.
B→T: N_{B}E(K_{B}, B_{cred}A_{id}N_{A}E(K_{A}, A_{cred}B_{id}))

Trent identifies that the message has come from Bob because Trent knows that the number N_{B} is associated with Bob. Trent decrypts the message using K_{B} and checks the credentials B_{cred}. Trent also decrypts and verifies the part of the message constructed by Alice. If Bob's credentials B_{cred} match his number N_{b} and his identifier B_{id} provided by Alice and Alice's credentials A_{cred} match her number N_{A} and her identifier A_{id} provided by Bob, Trent verifies the request. After verifying the request, Trent generates a message for Alice and a message for Bob. The message for Alice includes a new number N_{A}′, a new secret key K_{A}′, Alice's credentials A_{cred}, and a session key K_{AB}. Trent encrypts the message for Alice with Alice's current secret key K_{A}. The message for Bob includes a new number N_{B}′, a new secret key K_{B}′, Bob's credentials B_{cred}, and a session key K_{AB}. Trent encrypts the message for Bob with Bob's current secret key K_{B}. Trent sends the messages to Alice and Bob.
T→A: E(K_{A}, N_{A}′K_{A}′A_{cred}K_{AB})
T→B: E(K_{B}, N_{B}′K_{B}′B_{cred}K_{AB})

The above protocol can be extended to include more entities. For example, if Alice wants a session key associated with Bob and Carol, Alice can list known identifiers of Bob and Carol, such as Bob's identifier B_{id} and an identifier of Carol (e.g., C_{id}) in her message. Similarly, Bob can list identifiers of Alice and Carol, and Carol can list identifiers of Alice and Bob. Each entity can also include their credentials in their message. As shown above, each entity can forward their message to another entity associated with the requested session key and each entity can add their message to the received message. Once all the intended entities have added their message to the request, the last entity forwards the request to Trent. Trent verifies that the credentials of each entity match the mutating IDs (e.g., the numbers of the mutating IDs) assigned to each entity and that the list of identifiers specified by each entity match the provided credentials. After verifying the request, Trent sends a new mutating ID (e.g., a new number and a new secret key) and the session key associated with the listed entities to each entity along with their credentials.

Content Use Licenses

Mutating IDs can also be used to provide a license that an entity can use to obtain and decode a piece of content. For example, assume Alice has content or a message P that she wants to securely send to Bob. Again assume that Alice and Bob trust Trent and that Trent assigns Alice a mutating ID that includes a number N_{A} and a secret key K_{A} for some symmetric cipher and assigns Bob a mutating ID that includes a number N_{B} and a secret key K_{B} for some symmetric cipher. Also assume that Alice and Bob each have credentials (e.g., A_{cred} and B_{cred} respectively) that are known only to Trent and the holder of the credentials.

To obtain a license for the message P, Alice generates a hash of the message P, concatenates the hash H(P) with her credentials A_{cred}, and encrypts the result with her secret key K_{A}. Alice also appends her number N_{A} to the encryption result. Alice sends a license request to Trent.
A→T: N_{A}E(K_{A}, A_{cred}H(P))

Trent decrypts the request from Alice and generates a response to Alice that includes a mutating ID that includes a new number N_{A}′ and a new secret key K_{A}′ for Alice, a mutating ID to be associated with a license for the message P that includes a license number N_{H(P)} and a license secret key K_{H(P)}, and a key K_{P} for the message P. In some embodiments, Trent also includes the hash H(P) in the response to Alice so that Alice can ensure that the message has not been tampered with. Trent encrypts the response with Alice's current secret key N_{A} and sends the encrypted response to Alice.
T→A: E(K_{A}, N_{A}′K_{A}′N_{H(P)}K_{H(P)}K_{P}H(P))

Once Alice obtains the response from Trent, Alice decrypts the response and obtains the key K_{P} and the mutating ID associated with a license for the message P. Alice encrypts the message P with the key K_{P} and generates a license for the encrypted message P. The license for the encrypted message P includes Alice's credentials A_{cred} and the hash of the message H(P). In some embodiments, the license also includes an identifier of the recipient of the license. For example, if Alice is going to send the license to Bob, the license can include an identifier of Bob, such as B_{id}. In some embodiments, an identifier of the recipient is excluded from the license in order to reduce the complexity of the protocol. For example, digital media production companies may not know ahead of time or track potential recipients of the content. Alice encrypts the license with the license secret key K_{H(P)} and appends the associated license number N_{H(P)} to the encryption result. Alice sends the encrypted message and the associated license to Bob.
A→B: E(K_{P}, P) (encrypted content)
A→B: N_{H(P)}E(K_{H(P)}, A_{cred}H(P) B_{id}) (license)

At some point after receiving the encrypted message and the associated license, Bob can request the decryption key for the encrypted message P. To generate a request for the decryption key, Bob concatenates his credentials B_{cred} to the license Alice generated and encrypts the result with his secret key K_{B}. Bob also appends his number N_{B} to the encrypted concatenation and sends the request to Trent.
B→T. N_{B}E(K_{B},B_{cred}N_{H(P)}E(K_{H(P)}, A_{cred}H(P) B_{id}))

Trent unrolls the encryption, and, if an identifier of Bob is included in the license, Trent verifies that the credentials B_{cred} and the number N_{B} match the identifier in the license Alice generated. Trent can also verify that the hash H(P) matches the license number N_{H(P)} and the license secret key K_{H(P)}. After verifying the message from Bob, Trent sends Bob the key K_{P} that can be used to decrypt the encrypted message P, a mutating ID that includes a new number N_{B}′ and a new secret key K_{B}′ for Bob, and Bob's credentials B_{cred} all encrypted with Bob's current secret key K_{B}.
T→B: E(K_{B}, N_{B}′K_{B}′K_{P}B_{cred})

If desired by Alice, Trent can inform Alice that Bob requested the decryption key.
T→A: E(K_{A}′, “Bob requested the key associated with the identifier H(P)”)

After providing the decryption key to Bob, the license Alice provided to Bob is no longer valid because Trent has already seen the license number N_{H(P)} and the license secret key K_{H(P)} that comprise, in this instance, the one-time use mutating ID associated with the license for the message P.

As in the previous example, this protocol can be extended to include multiple entities by having each entity add their credentials to the license, encrypt the result with their assigned mutating ID, and forward the modified license to the next entity. For example, if Alice generates and sends a license to Carol who forwards the license to David who then sends the license to Bob, the resulting license received by Trent would be as follows:
T→A: N_{B}E(K_{B}, B_{cred} N_{D}E(K_{D}, D_{cred} N_{C}E(K_{C}, C_{cred} N_{H(P)}E(K_{H(P)}, A_{cred} H(P) B_{id}))))
Digital Signatures

So far we have discussed the use of mutating identifiers to establish a session and to deliver a license. In another embodiment, mutating IDs are used as digital signatures. Assume that Alice and Bob each have a copy of a document S that includes a piece of information P that requires an agreement between Alice and Bob. For example, the document S can include a bill of sale and the piece of information P can include the final price for the bill of sale. Also assume that Carol is an arbiter of agreements (e.g., a credit card company or a bank) such that she may need to know the piece of information P but not necessarily the document S. Again assume that Alice, Bob, and Carol trust Trent and that Trent assigns Alice a mutating ID that includes a number N_{A} and a secret key K_{A} for some symmetric cipher, assigns Bob a mutating ID that includes a number N_{B} and a secret key K_{B} for some symmetric cipher, and assigns Carol a mutating ID that includes a number N_{C} and a secret key K_{C} for some symmetric cipher. Also assume that Alice, Bob, and Carol each have credentials (e.g., A_{cred}, B_{cred}, and C_{cred} respectively) that are known only to Trent and the holder of the credentials.

To initiate the signing of the document S, Alice generates a message that includes the document S or the hash of the document S and a hash of her credentials A_{cred}. In some embodiments, Alice disguises or encodes the message. For example, Alice can generate an XOR of the hash of the document S and her credentials A_{cred}. The message can also include the piece of information P. Alice encrypts the message with her secret key K_{A}, appends her number N_{A}, and sends the result to Bob.
A→B: N_{A}E(K_{A}, XOR(H(S), H(A_{cred}))P)

Bob generates a similar message that can include an XOR of the hash of the document S and a hash of his credentials B_{cred}. In some embodiments, Bob also adds the piece of information P to the message. Bob adds his message to the message from Alice and encrypts the result with his secret key K_{B}. Bob also appends his number N_{B} and sends the result to Trent.
B→T: N_{B}E(K_{B}, XOR(H(S), H(B_{cred}))P N_{A}E(K_{A}, XOR(H(S), H(A_{cred}))P))

Trent decrypts the message from Bob and verifies that the hashes of the document S generated by Alice and Bob are equivalent. If Alice and Bob included the piece of information P in their messages, Trent also verifies that the pieces of information P provided from Alice and Bob are equivalent. After verifying the message, Trent generates receipts for Alice and Bob. Alice's receipt includes an identifier of Bob (e.g., B_{id}), the hash of the document S, and, optionally, the piece of information P. Trent encrypts Alice's receipt with a receipt secret key K_{receipt} that is part of a mutating ID associated with the receipts for Alice and Bob. Trent also appends an associated receipt number N_{receipt} included in the mutating ID associated with the receipts for Alice and Bob to Alice's receipt. Trent then encrypts Alice's receipt, a mutating ID that includes a new number N_{A}′ and a new secret key K_{A}′ for Alice, and Alice's credentials A_{cred} with Alice's current secret key K_{A} and sends the result to Alice.
T→A: E(K_{A}, N_{A}′K_{A}′A_{cred} N_{receipt}E(K_{receipt}, B_{id} H(S) P))

Trent generates a similar receipt for Bob that includes an identifier of Alice (e.g., A_{id}), the hash of the document S, and, optionally, the piece of information P. Trent encrypts Bob's receipt with the same receipt key K_{receipt} as he encrypted Alice's receipt and appends the same receipt number N_{receipt} as he appended to Alice's receipt. Trent encrypts Bob's receipt, a sixth mutating ID that includes a new number N_{B}′ and a new secret key K_{B}′, and Bob's credentials B_{cred} with Bob's current secret key K_{B} and sends the result to Bob.
T→B: E(K_{B}, N_{B}′ K_{B}′ B_{cred} N_{receipt} E(K_{receipt}, A_{id} H(S) P))

Alice and Bob present their receipts to Carol, and Carol forwards one or both of the receipts to Trent for verification. For example, assume that Alice provides her receipt to Carol. Carol adds her credentials to Alice's receipt and encrypts the result with her secret key K_{C}. Carol appends her number N_{C} to the result and sends the message to Trent.
C→T: N_{C}E(K_{C}, C_{cred} N_{receipt} E(K_{receipt}, B_{id} H(S) P))

Trent decrypts the message from Carol and verifies Alice's receipt by decrypting the receipt (since Trent and only Trent knows K_{receipt}) and providing Carol with the receipt details. For example, Trent can generate a message for Carol that includes a mutating ID that includes a new number N_{C}′ and a new secret key K_{C}′ for Carol, Carol's credentials C_{cred}, an identifier of Alice (e.g., A_{id}), an identifier of Bob (e.g., B_{id}), the hash of the document S, and, optionally, the piece of information P. Trent encrypts the message with Carol's current secret key K_{C} and sends the result to Carol.
T→C: N_{C}E(K_{C}, N_{C}′ K_{C}′ C_{cred} A_{id} B_{id} H(S) P)

Carol can use the information from Trent to arbitrate the agreement between Alice and Bob.

It should be understood that the above protocol can be expanded to include other numbers of entities.

As illustrated in the above examples, mutating IDs offer several advantages over static values when used in the above protocols. A first advantage is that an eavesdropper or attacker must capture the entire mutation history of an identifier or key of a mutating ID in order to attempt a ciphertext-only brute force attack.

A second advantage of mutating IDs is that they provide a unique form of security and intrusion detection. The history of an entity's mutating IDs is kept as an audit trail by the authenticator device 28 as the entity's “mutating ID lineage.” The mutating ID lineage tracks who each mutating ID as assigned to, the time the mutating ID was assigned, and the time the mutating ID was used. If a mutating ID or a portion thereof is somehow copied, stolen, or activated by an entity other than the authenticator device 28, one of two events will take place. In a first event, if the rightful owner of a mutating ID uses the mutating ID before an imposter does, the stolen or copied mutating ID that the imposter possess becomes obsolete and a future use of the mutating ID by the imposter will be immediately detected by the authenticator device 28. In a second event, if an attacker or imposer uses a stolen mutating ID before the mutating ID is used by the rightful owner, the mutating ID will become obsolete before the rightful owner uses the mutating ID. At a later time when the rightful owner does use the mutating ID, the authenticator device 28 will immediately identify the mutating ID as obsolete and the rightful owner of the mutating ID can be notified of the intrusion so that proper actions can be taken.

A third advantage of mutating IDs is that an entity can obtain a new mutating ID using an existing mutating ID at any time during the protocol regardless of the whether the entity has used the existing mutating ID. This periodic mutation can limit the time that an attacker has to steal a mutating ID and use a stolen mutating ID.

Black Protocol

The secret keys of mutating IDs (e.g., K_{A}, K_{B}, K_{C}, and K_{D}) should remain secret in order to protect the security of the transmitted data. For example, if Trent provides Alice with a new mutating ID encrypted with Alice's current secret key (e.g., K_{A}), an eavesdropper who has determined Alice's current secret key can obtain Alice's new mutating ID provided by Trent. The eavesdropper can then use the new mutating ID to send false data and/or obtain the plaintext of future data exchanged between Alice and Trent.

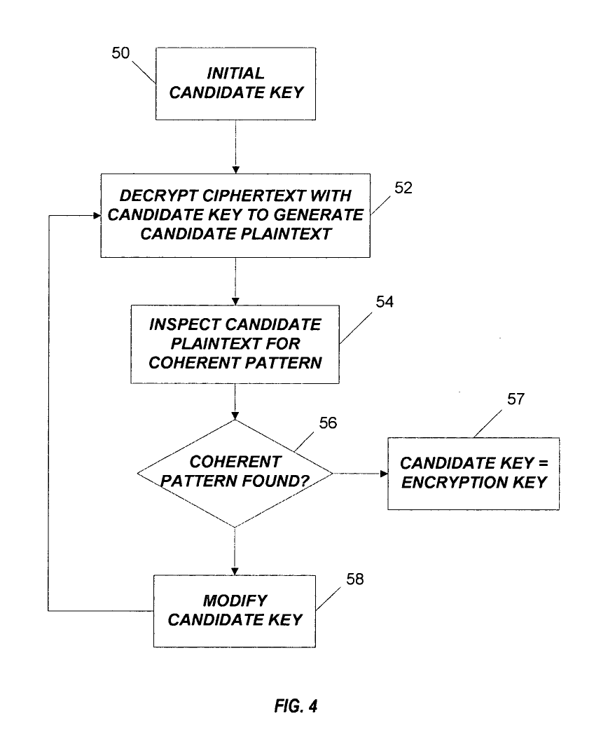

As described above, eavesdroppers can determine (or attempt to determine) a key used to encrypt particular data by performing an attack. FIG. 4 illustrates a brute force attack. A brute force attack includes decrypting ciphertext with every possible key until a key is found that produces coherent or recognizable data (e.g., human readable data). As shown in FIG. 4, an eavesdropper determines an initial or zero candidate key (step 50). The eavesdropper then uses the candidate key to decrypt ciphertext (step 52). After decrypting the ciphertext, the eavesdropper can inspect the result (i.e., the candidate plaintext) to determine if the ciphertext decrypted with the candidate key produces coherent plaintext or a coherent pattern (step 54). If the eavesdropper obtains or knows the plaintext (or a portion or pattern thereof) corresponding to the obtained ciphertext, the eavesdropper can more easily determine whether a correct candidate key has been found. For example, if the eavesdropper obtains ciphertext and knows that the ciphertext includes an individual's name followed by a 4-digit personal identification number (“PIN”), the eavesdropper can apply candidate keys until a candidate key produces the plaintext including the individual's name. The eavesdropper can then assume, with some certainty, that remaining information included in the generated plaintext corresponds to the PIN.

As shown in FIG. 4, if the eavesdropper finds a coherent pattern in candidate plaintext generated by decrypting ciphertext with a particular candidate key (step 56), the eavesdropper knows, with some certainty, that the current candidate key equals or is the key used to generate the ciphertext (step 57).

If the eavesdropper does not find a coherent pattern in the candidate plaintext generated by decrypting ciphertext with a particular candidate key (step 56), the eavesdropper can modify the candidate key (e.g., increment the candidate key) (step 58), and can use the modified candidate key to decrypt the ciphertext (step 52) and inspect the generated candidate plaintext for coherent plaintext or a coherent pattern (step 54). Given enough processing power and time, the eavesdropper can continue this process until a particular candidate key generates candidate plaintext with coherent plaintext or a coherent pattern and, therefore, determine the key used to generate the ciphertext.

However, if the eavesdropper has no knowledge of the plaintext or a pattern of the plaintext (i.e., has no content hint), the eavesdropper's ability to determine whether a correct candidate key has been found is greatly reduced and, perhaps, eliminated. For example, if plaintext includes a random number encrypted with a particular key, no matter how many keys the eavesdropper attempts in a brute force attack, the eavesdropper will have no way to determine whether candidate plaintext is the true plaintext corresponding to the ciphertext. Assuming that the key space (i.e., the pool of candidate keys) and the plaintext space of the encryption algorithm (i.e., the pool of candidate plaintext) are substantially the same, decrypting an encrypted random number with any candidate key will produce a random number that is equally likely to be the original random number as every other random number produced by every other candidate key.

Referring to the session key exchange example described above involving Alice, Bob, and Trent, if any portion of an encrypted message is recognizable, known, becomes known, or includes any content hints, an eavesdropper could possibly perform a plaintext or partial-plaintext attack on the encrypted message and uncover a secret key of Alice or Bob used to encrypt the message. For example, assume that Alice sends the following message to Bob that is intercepted by an eavesdropper.
A→B: N_{A}E(K_{A}, A_{cred} B_{id})

The eavesdropper can perform a brute force attack on the intercepted message because Bob's identifier B_{id} and the format of the above message are known or public. Thus, the eavesdropper can obtain Alice's secret key K_{A} and her credentials A_{cred}. Furthermore, once the eavesdropper obtains Alice's current secret key K_{A}, the eavesdropper can use Alice's current secret key K_{A} to obtain all data encrypted with Alice's current secret key K_{A}, such as her next mutating ID (e.g., N_{A}′ and K_{A}′).

An eavesdropper can use other knowledge about an encrypted message or the communication protocol used to generate an encrypted message to perform brute force attacks. For example, an eavesdropper can use the mutating ID number (e.g., N_{A}), which is passed in the clear, to perform a brute force attack. An eavesdropper could also use knowledge of the algorithm used to generate the mutating ID numbers to perform a brute force attack.

Keys used to encrypt undiscoverable or “black” data (i.e., data that is random or has no content hints) cannot be determined or discovered using a brute force attack, since an eavesdropper will be unable to determine when a correct candidate key is found. Keys used to encrypt discoverable or “white” data (i.e., data that is known, may be later disclosed, is recognizable, or has a known or easily guessed format), however, can (theoretically) be determined using a brute force attack. When the white data and the black data are encrypted together or with the same encryption key, the key determined through a brute force attack using the white data is also the key used to encrypt the black data and, therefore, the black data can be discovered.

To increase the security of encrypted data and to reduce the effectiveness of brute force attacks, some embodiments of the invention provide an encryption strategy that protects the security of black data, such as the secret keys included in mutating IDs.

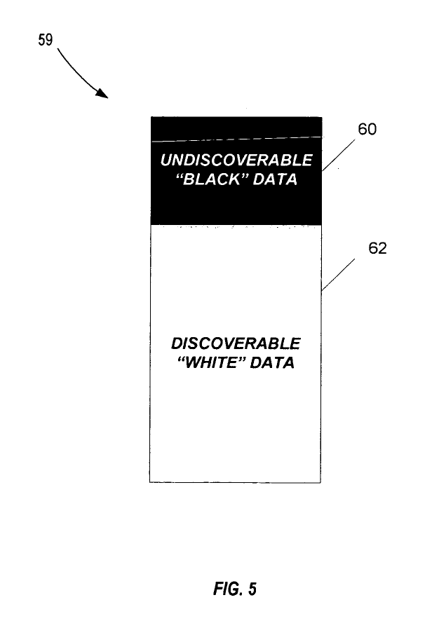

FIG. 5 illustrates types of data that can be included in data that is to be encrypted. As shown in FIG. 5, data 59 that is to be encrypted and transmitted to a particular receiver is separated into types or classes of data. A first class of data includes a black data class 60. The black data class 60 includes data that is kept secret and only known by authorized entities. For example, the black data class 60 can include the secret keys of the mutating IDs and/or the credentials of the entities included in the system 20, which are both random and known only by the authenticator device 28 and the holder of the credentials and the secret keys.

As shown in FIG. 5, a second class of data includes a white data class 62. The white data class 62 includes data that is publicly-known, recognizable (e.g., human-readable), or has a known or easily guessed format. For example, the white data class 62 includes data that has easily distinguished characteristics, such as standardized headers, known patterns, or other publicly available formats, such as content transmitted between entities (e.g., human-readable messages, movies, etc.) and the numbers (e.g., N_{A}, N_{B}, N_{C}, and N_{D}) of the mutating IDs provided by authenticator device 28.

The white data class 62 also includes indirect white data or keys used to encrypt messages that include white data, such as the secret keys (e.g., K_{A}, K_{B}, K_{C}, and K_{D}) of the mutating IDs. For example, as described above with respect to the session key exchange protocol, Alice sends Bob a message that includes Bob's publicly-known identifier B_{id} encrypted with her secret key K_{A}.
A→B: N_{A}E(K_{A}, A_{cred} B_{id})

Since Bob's identifier B_{id} is publicly known and, therefore, is white data, Alice's secret key K_{A} can be considered indirect white data because it encrypts data that is publicly-known.

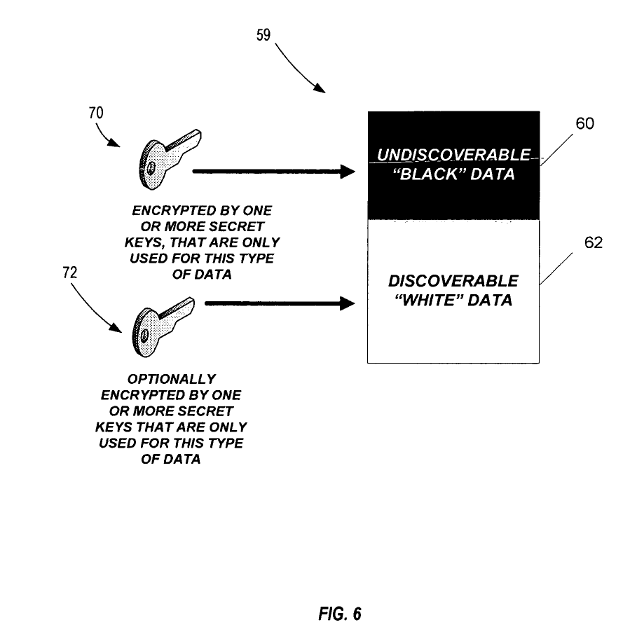

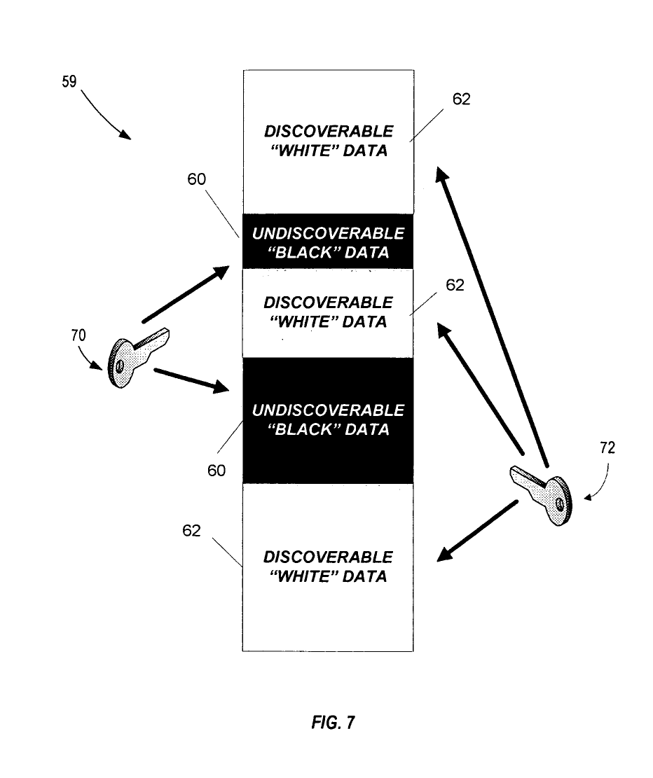

FIGS. 6 and 7 illustrate an encryption strategy for protecting the security of black data according to one embodiment of the invention. To protect the security of the black data, separate keys can be used to encrypt the different types of data (hereinafter referred to as “separate encryption protocols”). For example, one or more keys (perhaps keys that are part of one or more mutating IDs) can be used to encrypt the black data and one or more different keys (perhaps keys that are part of one or more different mutating IDs) can be used to encrypt the white data. As described below, since the same keys are never used to encrypt black data and white data, the security of the black data is increased.

As shown in FIG. 6, data included in the black data class 60 can be encrypted with one or more keys 70 that are only used to encrypt black data (hereinafter referred to in this example as “black data keys 70”). Optionally, data included in the white data class 62 can be encrypted with one or more keys 72 that are only used to encrypt white data (hereinafter referred to in this example as “white data keys 72”). It should be understood that the black data keys 70 cannot be determined from (or are unrelated to) the white data keys 72. It should also be understood that the data 59 does not need to be separated and placed in contiguous blocks of data according to the data class the portions of the data 59 belong to. As shown in FIG. 7, data included in the black data class 60 and the white data class 62 can be divided into a number of portions that are mixed together.

By separating the black data from the white data and encrypting the black data with keys 70 that are different from the keys 72 used to encrypt the white data, even if a white data key 72 used to encrypt white data is determined using a brute force attack, the determined white data key 72 cannot be used to obtain black data.

### Exchanging Randomly-Generated Secret Content

In the following examples, the subscript i is used to denote an iteration count, where i is initially set to 0 or another predetermined value and is incremented by both parties involved in a protocol exchange after each exchange and/or on a different predetermined schedule. Therefore, the current value of a particular item is denoted with a subscript of i and a new or mutated value of the item is denoted with a subscript of i+1, rather than with a superscript of 'as was used in previous examples.

The separate encryption protocol can be used to allow two entities to exchange randomly-generated secret data. For example, assume that a first entity A wants to exchange randomly-generated secret content Sᵢ (i.e., black data) with a second entity B. Entities A and B previously-established randomly-generated secret encryption key Kᵢ. Entities A and B can agree on the key Kᵢ in person, one entity can send the secret key Kᵢ to the other entity via secure communication means, the secret key Kᵢ can be pre-stored in software or hardware operated by the entities, etc.

After establishing the secret encryption key Kᵢ, entity A encrypts the secret data Sᵢ and a new secret, random encryption key Kᵢ₊₁ with the encryption key Kᵢ. Alice randomly generates the new secret key Kᵢ₊₁. Entities A and B use the new secret key Kᵢ₊₁ to encrypt secret data in a future data exchange.
A→B: E(Kᵢ, Kᵢ₊₁ Sᵢ)

In some variants, entity A can generate an XOR of the encryption key Kᵢ and the new encryption key Kᵢ₊₁.
XOR(Kᵢ, Kᵢ₊₁)

After performing the XOR operation, entity A encrypts the bit string resulting from the XOR operation and the secret data Sᵢ with the encryption key Kᵢ and sends the result to entity B.
A→B: E(Kᵢ, XOR(Kᵢ, Kᵢ₊₁) Sᵢ)

Using knowledge of the encryption key Kᵢ, entity B can determine the new encryption key Kᵢ₊₁.

For both cases, the message from entity A includes two parts: a key-mutation part (i.e., Kᵢ₊₁ or XOR(Kᵢ, Kᵢ₊₁)) and a secret content part (i.e., Sᵢ). Also in both cases, the key-mutation part is randomly-generated by entity A, and subsequent key-mutations are independent of prior key values.

Assuming the key space of the secret keys Kᵢ and the plaintext space of the encryption function E are isomorphic, every candidate value of the secret key Kᵢ will yield a completely possible candidate cleartext, and each candidate cleartext contains enough information to calculate a completely possible next key value. Therefore, an eavesdropper cannot rule out any possible initial key values and the protocol is substantially impervious to a ciphertext-only brute force attack.

### Communicating with an Authenticator

Separate encryption protocols can also be used by the entities of the system 20, as shown in FIG. 1, to communicate with the authenticator device 28 in order to request session keys, request licenses, etc. For example, assume Alice, represented by the first device 22 wants to send a request to Trent, represented by the authenticator device 28. Trent has previously assigned Alice an initial randomly-generated secret encryption key, Kᵢ, and a corresponding initial public identifier Nᵢ (e.g., which may be part of a mutating ID assigned by Trent).

The parties also agree on a request and response protocol, which is shown in generalized form as a request consisting of a black request parameter set, B_{REQ}, and a white request parameter set, W_{REQ}, and a black response parameter set, B_{RSP}, and a white response parameter set, W_{RSP}. In some implementations, some of the parameter sets may be empty. Both the white request parameter set W_{REQ} and the white response parameter set W_{RSP} include publicly-known (i.e., white or discoverable data) request and response parameters, respectively. The black request parameter set B_{REQ} is underivable from the white request parameter set W_{REQ}.

In some embodiments of the invention, a white request parameter set W_{REQ} is paired with the black request parameter set B_{REQ} in order to form a valid request. Since the black request parameter set B_{REQ} cannot be determined or derived from the white request parameter set W_{REQ}, an eavesdropper cannot make a request to Trent posing as Alice without also providing the black request parameter set B_{REQ}. As noted, however, black content is undiscoverable. Therefore, knowledge of the white request parameter set W_{REQ} alone, does not allow an eavesdropper to forge a request. Similarly, the white response parameter set W_{RSP} is paired with the black response parameter set B_{RSP} and an eavesdropper who obtains the white response parameter set W_{RSP} could not send a response to Alice posing as Trent without also knowing the corresponding black response parameter set B_{RSP}.

To send a request, Alice encrypts the black request parameter set B_{REQ} with the encryption key Kᵢ. To identify herself as the sender of the request to Trent, Alice appends the public identifier Nᵢ to the encryption result. In some variants, Alice also appends the corresponding white request parameter set W_{REQ} to the encryption result. Alice sends the resulting message to Trent.
A→T: Nᵢ W_{REQ} E(Kᵢ, B_{REQ})

In some variants, Trent can assign Alice a separate encryption key that Alice can use to encrypt white data, such as the white request parameter set W_{REQ}. The encrypted white data is appended to the encrypted black response parameter set B_{REQ}. To prevent cipher-text-only brute force attacks from successfully identifying the randomly-generated secret black request parameter set B_{REQ} and the encryption key Kᵢ, however, the white request parameter set W_{REQ} and any other white data cannot be encrypted in the same encryption package or envelope as the black request parameter set B_{REQ} or any other black data.

Trent receives the message from Alice and identifies Alice as the sender based on the identifier Nᵢ appended to the message. After Trent determines that Alice sent the message, Trent uses the encryption key Kᵢ to decrypt the message and obtain the black request parameter set B_{REQ}. Trent verifies that the black request parameter set B_{REQ} is valid. If Alice also provided the white request parameter set W_{REQ}, Trent also verifies that the white request parameter set W_{REQ} is valid (e.g., that there is a proper association or matching between it and the black request parameter set B_{REQ}). If the white request parameter set W_{REQ} is invalid, Trent rejects the request. Mismatched parameter sets can also signal that the request message was been tampered with (e.g., by a man-in-the middle attack) or may have been sent by an imposter.

To send a response to Alice, Trent encrypts the black response parameter set B_{RSP} and a new randomly-generated, secret encryption key Kᵢ₊₁ with the current encryption key Kᵢ. In some variants, as described above, Trent replaces the new encryption key Kᵢ₊₁ in the response to Alice with the results of performing an XOR operation on the current encryption key Kᵢ and the new encryption key Kᵢ₊₁. Trent also generates a new identifier Nᵢ₊₁ for Alice and appends the new identifier Nᵢ₊₁ to the result of the encryption. In some variants, Trent also appends the corresponding white response parameter set W_{RSP} to the encryption result. As described above, rather than appending the white response parameter set W_{RSP} as plaintext, Trent can encrypt the white response parameter set W_{RSP} with a white data key known by Trent and Alice. In addition, Trent can use the white data key to provide Alice with a new or mutated white data key. Trent sends the resulting message to Alice.
T→A: Nᵢ₊₁ W_{RSP} E(Kᵢ, XOR(Kᵢ, Kᵢ₊₁) B_{RSP})

Trent also marks the current encryption key Kᵢ and the current identifier Nᵢ as used and ensures that the key and the identifier are not reused for a long time. In some embodiments, Trent tracks the time that a key or identifier was issued and the time that it was later used in a request. Trent can use this information to make sure that a key or identifier is not reused until a predetermined amount of time has passed and/or to track when a key or identifier was used in improperly (e.g., by an entity posing as the rightful owner of the key or identifier).

Alice decrypts the message from Trent and obtains the new encryption key Kᵢ₊₁ and the black response parameter set B_{RSP}. Alice verifies that the black response parameter set B_{RSP} is valid. If the black response parameter set B_{RSP} is invalid, Alice can identify that the response was not sent by Trent and can disregard the response. If the message from Trent also includes the white response parameter set W_{RSP}, Alice also verifies that the white response parameter set W_{RSP} is valid. If the white response parameter set W_{RSP} is invalid, Alice can identify that the response was not sent by Trent and can disregard the response.

### Black Protocol with Message Authentication

The protocols described above introduced separate encryption of black data using a mutating key or identifier (which can be parts of mutating IDs). Although the above protocols protect black data from ciphertext-only brute force attacks, the protocols provide limited message authentication or anti-tampering mechanisms. Consequently, an attacker may be able to inject bad data in to a message.

One way to provide message authentication and an anti-tampering mechanism involves Trent assigning Alice an initial large secret key Kᵢ. Trent and Alice also independently keep an iteration count i. Alice and Trent can independently update or increment the iteration count i after each exchange and/or on another predetermined schedule.

Alice uses the large secret key Kᵢ and the iteration count i to exchange secret data (i.e., black data) Sᵢ with Trent. For example, Trent can send Alice the secret data Sᵢ using the following message protocol.
T→A: E(K_{FX}(i, Kᵢ), Sᵢ Mᵢ H(I_{FX}(i, Kᵢ), Sᵢ Mᵢ F_{EX}(i, Kᵢ)))

In the above message protocol, Trent encrypts a message to Alice with an encryption key generated by a key function K_{FX}. The key function K_{FX} generates a symmetric encryption key value using the iteration count i and the large secret key Kᵢ.

The contents of the message from Trent to Alice include the secret data Sᵢ, a mutation value Mᵢ, and the result of a mutating secure-hash function H. The mutation value Mᵢ is a randomly generated number based on the iteration count i and uniquely identifies a message.

The secure-hash function H generates a secure hash of contents of the message from Alice to Bob. In the above example, the secure-hash function H generates a secure hash of the secret data Sᵢ, the mutation value Mᵢ, and the large secret key Kᵢ or a portion thereof. To use only a portion of the large secret key Kᵢ in the hash, an extract function F_{EX} can be used. The extract function F_{EX} extracts and returns a portion of the large secret key Kᵢ based on the iteration count i. In some variants, the extract function F_{EX} returns the entire large secret key Kᵢ.

The secure-hash function H is initialized with an initialization value, such as an initialization vector I. The initialization vector I is generated with an initialization vector function I_{FX}. The initialization vector function I_{FX} generates an initialization vector I based on the iteration count i and the large secret key Kᵢ.

Alice can decrypt the message from Trent since Alice knows the iteration count i, the large secret key Kᵢ, and the functions used in the message. Decrypting the message allows Alice to obtain the secret data Sᵢ, the mutation value Mᵢ, and the hash H(I_{FX}(i, Kᵢ), Sᵢ Mᵢ F_{EX}(i,Kᵢ)). To make sure that the message from Trent was not tampered with during transmission, Alice authenticates the message from Trent by generating her own version of the hash that Trent included in the message. To generate her own version of the hash, Alice generates a hash of the secret data Sᵢ and mutating value Mᵢ obtained from the message from Trent and the large secret key Kᵢ. Alice uses the same secure hash function H as Trent. In some variants, Alice also generates an initialization vector I_{FX} for the hash function H as Trent did. In addition, Alice can use the same extraction function F_{EX} to extract a portion of the large secret key Kᵢ to use in the hash as Trent did.

After generating her own version of the hash, Alice compares her version of the hash to the hash included in the message from Trent. If the hashes match or are the same, Alice can assume that the message from Trent was not tampered with. If the hashes do not match, it is likely that the message was tampered with and Alice can disregard it.

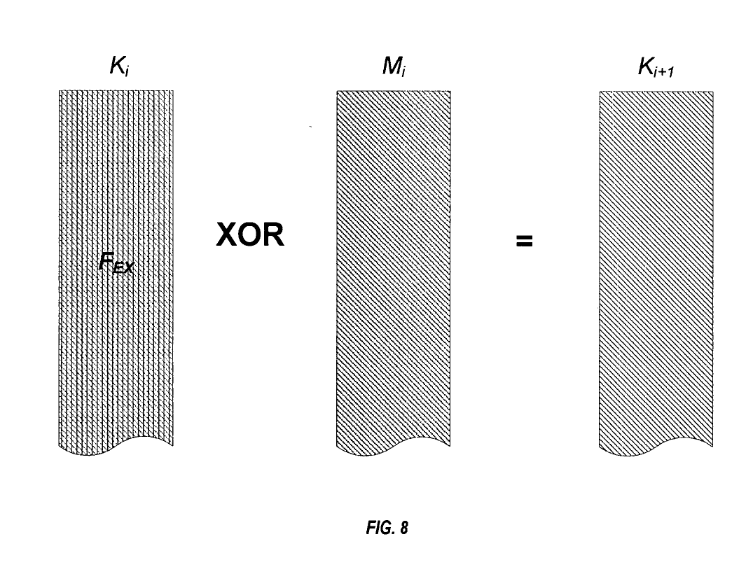

In some embodiments, Alice and Trent each individually mutate the large secret key Kᵢ before using the large secret key Kᵢ in a subsequent message. To accomplish this, Alice and Trent use a mutation function F_{M} to mutate the large secret key Kᵢ. The mutation function F_{M} generates a new or mutated large secret key Kᵢ₊₁ based on the iteration count i, the mutation value Mᵢ used in the most recent message, and/or the current large secret key Kᵢ. For example, as illustrated in FIG. 8, the mutation function F_{M} can perform the function Mᵢ XOR Kᵢ, wherein Mᵢ and Kᵢ are substantially the same length.
Kᵢ₊₁=F_{M}(i, Mᵢ, Kᵢ)=Mᵢ XOR Kᵢ

Using the above message protocol, an attacker desiring to obtain the secret data Sᵢ or the large secret key Kᵢ using brute force must first learn all of the algorithms used in the message protocol. The attacker must also obtain all of the messages exchanged between Alice and Trent. Next, the attacker must assume a candidate key Cᵢ and use the candidate key Cᵢ to decrypt a first message (i.e., iteration zero) exchanged between Alice and Trent. Decrypting the first message with the candidate key Cᵢ reveals candidate text Xᵢ. Since the attacker knows the algorithms of the message protocol, the attacker can divide the candidate text Xᵢ into candidate secret data S_{iX}, a candidate mutation value M_{iX}, and a candidate secure-hash function result H_{iX}. Using the candidate secret data S_{iX}, the candidate mutation value M_{iX}, and the candidate key Cᵢ, the attacker creates his or her own version of the secure-hash function result H_{iT} (e.g., a test result of the secure-hash function H for iteration i). If the test result of the secure-hash function H_{iT} matches the candidate secure-hash function result H_{iX}, the attacker can mark the candidate key Cᵢ as an acceptable or potential candidate key. If the test result of the secure-hash function H_{iT} does not match the candidate secure-hash function result H_{iX}, the attacker can rule out the candidate key Cᵢ as a potential correct key.

For each acceptable or potential candidate key Cᵢ, the attacker applies the mutation function F_{M} and generates a candidate key Cᵢ₊₁ for the second or next message exchanged between Alice and Trent. The attacker can then use the mutated acceptable candidate key Cᵢ₊₁ to perform the above encryption and test process as described above for the first message.

Given a large set of randomly generated input buffers, an ideal secure hash produces an unbiased and evenly distributed set of output values that fall between 0 and (2^{h}−1), where h is the number of bits returned by the hash function. Because of the periodicity of the secure-hash function H, each message exchanged between Alice and Trent reduces the potential key space (the list of possible keys) by a factor of 2^{h}, where h is the number of bits returned by the secure-hash function H. If the secret key is m bits in length, the attack may be capable of determining the initial secret key (e.g., secret key Kᵢ) after (m/h) messages are exchanged.

To reduce the likelihood of success of a brute force attack, the large secret key Kᵢ can be reset before the (m/h)^{th} message is exchanged. In addition, if the large secret key Kᵢ is reset j messages before the (m/h)^{th} message is exchanged, a brute force attack would still leave 2^{jh} spurious large key values, and the correct or true large secret key value would be indistinguishable.

One possible embodiment of the invention can include a secure-hash function H that returns a 160-bit hash value and a large secret key Kᵢ including 64 kilobytes. Using these parameters, the message protocol as described above would allow over 3,000 messages to be exchanged with limited risk of an effective brute force attack. In addition, the extraction function F_{EX} and the mutation function F_{M} can be selected in such a way that a moving window portion of the large secret key Kᵢ is used in the message hash, and that the mutation of the large secret key Kᵢ occurs in relatively narrow strips while still impacting the next iteration of the large secret key Kᵢ. This can allow the protocol to have relatively low computational overhead, while maintaining approximately the same level of security.

As noted above and as shown in FIG. 8, in one embodiment the extraction function F_{EX}(i,Kᵢ) returns the entire large secret key Kᵢ, and the mutation function F_{M}(i, Mᵢ, Kᵢ) returns Mᵢ XOR Kᵢ, where Mᵢ and Kᵢ are equal length. Although these functions produce a working system, they can introduce substantial computational overhead for the secure hash function, since the entire large secret key Kᵢ is appended to the end of message prior to calculating the hash. The functions can also introduce substantial protocol overhead, since the mutation value transmitted in response to each request is as long as the large secret key Kᵢ.

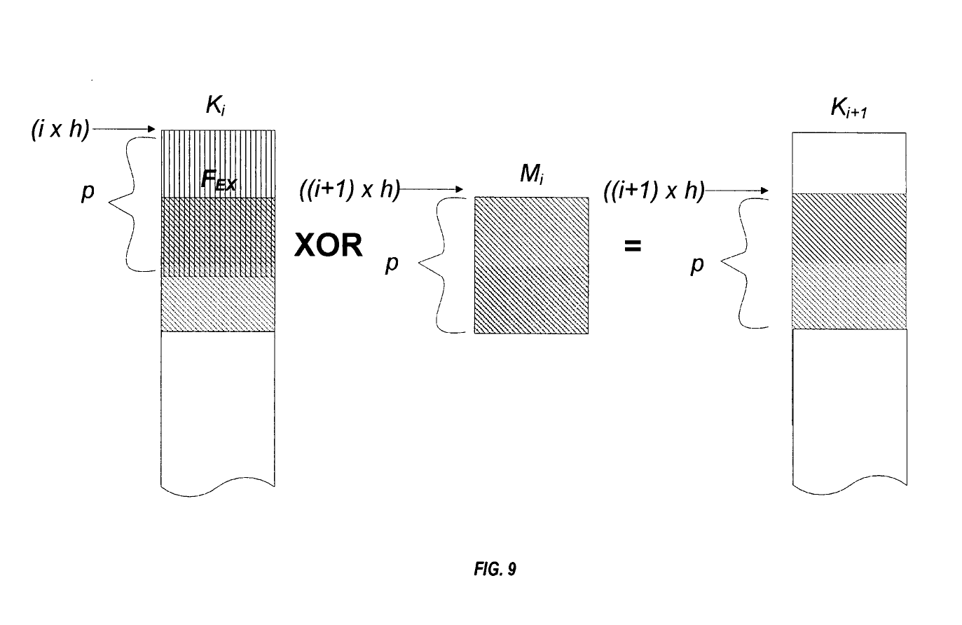

As shown in FIG. 9, to address the above overhead issues, the extraction function F_{EX} can be modified to select p bits of the large secret key Kᵢ at an offset of (i×h) bits from the start of the large secret key Kᵢ, where h is the number of bits returned by the secure hash function H. Thus, the used portion of the large secret key is ((i×h)+p) bits, and the ocean of spurious large keys contains 2^{p} values. Using this version of the extraction function F_{EX} allows for the use of larger secret key values without experiencing increased computational overhead in the calculation of the secure hash function.

Similarly, as also shown in FIG. 9, the mutation function F_{M} can receive a random mutation value of p bits and apply the mutation value via an XOR to the large secret key Kᵢ at an offset of ((i+1)×h) bits. In this way, the protocol overhead associated with the mutation is reduced to p bits and is independent of the size of the initial large secret key Kᵢ. In addition, all of the bits that will be used in the next iteration of the protocol are mutated, which eliminates any mathematical correlation between the two key values.

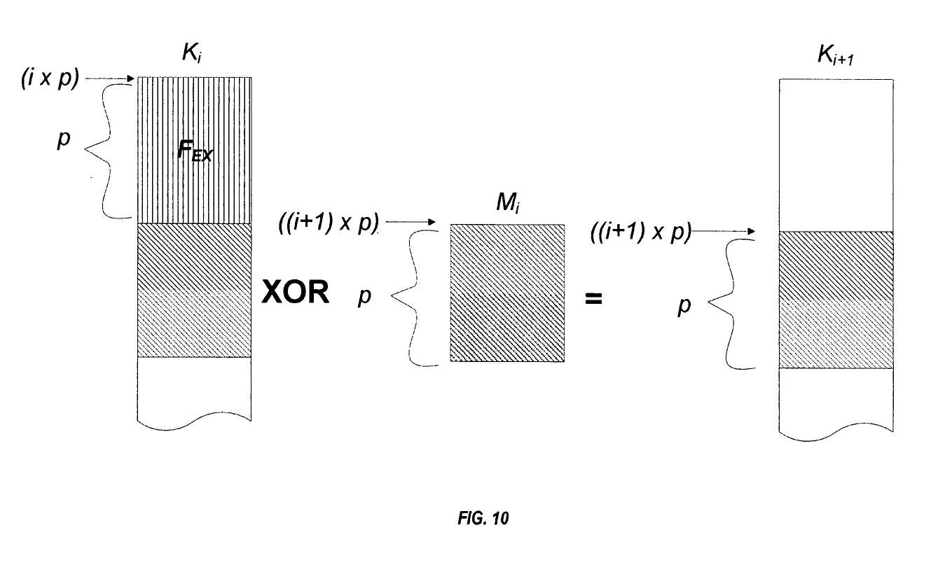

As shown in FIG. 10, the extract function F_{EX} can also be modified to select p bits of the large secret key Kᵢ at an offset of (i×p) bits from the start of the large secret key Kᵢ. Thus, an entirely-new portion of the large secret key Kᵢ is selected each time the extract function F_{EX} is used.

Similarly, as also shown in FIG. 10, the mutation function F_{M} can receive a random mutation value of p bits and apply the mutation value via an XOR to the large secret key Kᵢ at an offset of ((i+1)×p) bits.

Using this “updating in stripes” methodology, the initial large secret key Kᵢ can be quite large and the system can support a very large number of message exchanges before a reset of public identifiers and associated keys is needed.

### Black Protocol Requests and Responds

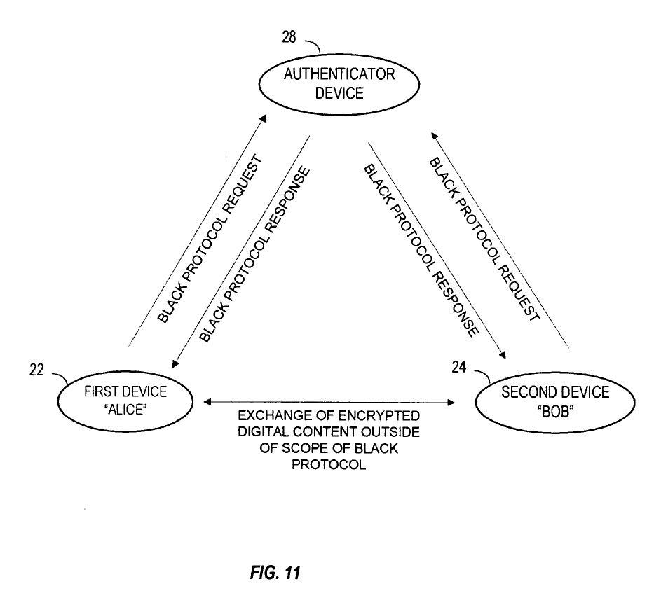

FIG. 11 illustrates how the black protocol can be used to exchange requests and responses between entities (e.g., the first device 22 and the second device 24) and an authenticator (such as the device 28). Implementations of the protocol can be used by an entity to request a periodic mutation of a mutating ID, to request an encryption key, to request a decryption key, to get an authentication token (e.g., credentials), and to request authentication of an authentication token. Similarly, the authenticator device 28 can use the black protocol to provide responses to the entity for each type of request. As shown in FIG. 8, an entity can communicate with other entities using the responses from the authenticator. For example, an entity can request an encryption key from the authenticator, receive an encryption key from the authenticator, use the encryption key to encrypt a message for another entity, and send the encrypted message to the other entity. As also shown in FIG. 8, the entity receiving the encrypted message can request a decryption key from the authenticator, receive a decryption key from the authenticator, and use the decryption key to decrypt the encrypted message.

In one embodiment, Trent (the authenticator device 28) assigns Alice (the first device 22) an initial public identifier Nᵢ, an initial secret key kᵢ, and an initial large secret key Kᵢ. The public identifier Nᵢ, the secret key kᵢ, and the large secret key Kᵢ can be referred to as large mutating ID. Trent and Alice also independently keep an iteration count i, which is often initialized with a value of zero. Alice and Trent can independently update or increment the iteration count i after each request, after each response, or on another predetermined schedule.

Alice uses the public identifier Nᵢ to identify herself as the originator of messages. Alice uses the secret key kᵢ (hereinafter referred to as Alice's white data key kᵢ) to encrypt white data, and Alice uses the large secret key Kᵢ for a variety of purposes, including encryption of black data. Alice may also use the large secret key Kᵢ as input to an initialization function I_{FX} in order to generate an initialization vector for a hash function H. In some embodiments, Trent assigns Alice a new or mutated public identifier Nᵢ and white data key kᵢ after each use or periodically as requested by Alice or enforced by Trent, and Trent and Alice each individually mutate the large secret key Kᵢ after each transaction or periodically as requested by Alice or enforced by Trent.

Using the large mutating ID, Alice generates a request for Trent by encrypting request parameters T_{REQ} with her white data key kᵢ. The request parameters T_{REQ} include any information that is needed by Trent to respond to a particular request, such as a hash of a content for which Alice is requesting an encryption key for. The request parameters T_{REQ} are considered white data. Alice appends her public identifier Nᵢ to the encryption result in order to identify herself as the sender of the request.
Nᵢ E(kᵢ, T_{REQ})

To provide message authentication for the request, Alice generates a hash of her public identifier Nᵢ, the request parameters T_{REQ}, and the large secret key Kᵢ using a secure-hash function H. As described above, in some variants, Alice uses only a portion of the large secret key Kᵢ in the hash and uses an extract function F_{EX} to extract a particular portion of the large secret key Kᵢ based on the iteration count i and/or the number of bits returned by the secure-hash function H. In addition, Alice can use the initialization function I_{FX} to generate an initialization vector for the hash function H based on the iteration count i and the large secret key Kᵢ.
H(I_{FX}(i, Kᵢ), Nᵢ T_{REQ} F_{EX}(i, Kᵢ)

Alice encrypts the hash with the large secret key Kᵢ or a portion thereof. For example, as described above, Alice can encrypt the hash with a portion of the large secret key Kᵢ determined by the key function K_{FX} based on the iteration count i.
E(K_{FX}(i, Kᵢ), H(I_{FX}(i, Kᵢ), Nᵢ T_{REQ} F_{EX}(i, Kᵢ))

Alice appends the encrypted hash to the encrypted request parameters with the appended public identifier Nᵢ and sends the result to Trent.
T→A: Nᵢ E(kᵢ, T_{REQ}) E(K_{FX}(i, Kᵢ) H(I_{FX}(i, Kᵢ), Nᵢ T_{REQ} F_{EX}(i, Kᵢ))

Upon receiving the request from Alice, Trent determines that Alice sent the request based on the identifier Nᵢ and decrypts the portions of the request using the white data key kᵢ and the large secret key Kᵢ. After Trent obtains the request parameters T_{REQ} and the hash from the request, Trent generates his own version of the hash based on the request parameters obtained from the request. To authenticate the request, Trent compares his version of the hash to the hash obtained from the request. If the hashes match, Trent can verify that the white data was not tampered with during transmission of the request from Alice to Trent.

To generate a response for Alice, Trent generates a new or mutated public identifier Nᵢ₊₁ and a new white data key kᵢ₊₁ for Alice. Trent encrypts the new white data key kᵢ₊₁ and the response parameters T_{RSP} with Alice's current white data key kᵢ. Trent appends the new public identifier Nᵢ₊₁ to the encryption result.
Nᵢ₊₁ E(kᵢ, kᵢ₊₁ T_{RSP})

To provide message authentication for the response, Trent generates a hash of Alice's new public identifier Nᵢ₊₁, Alice's new white data key kᵢ₊₁, the response parameters T_{RSP}, a random mutation value Mᵢ generated by Trent, and Alice's large secret key Kᵢ using the secure-hash function H. As described above, in some variants, Trent uses only a portion of the large secret key Kᵢ in the hash and uses the extract function F_{EX} to extract a particular portion of the large secret key Kᵢ based on the iteration count i and/or the number of bits returned by the secure-hash function H. In addition, Trent can use the initialization function I_{FX} to generate an initialization vector for the hash function H based on the iteration count i and the large secret key Kᵢ.
H(I_{FX}(i, Kᵢ), Nᵢ₊₁ kᵢ₊₁ T_{RSP} Mᵢ F_{EX}(i, Kᵢ)

Trent encrypts the hash and the mutation value Mᵢ included in the hash with Alice's large secret key Kᵢ or a portion thereof. For example, as described above, Trent can encrypt the hash with a portion of the large secret key Kᵢ determined by the key function K_{FX} based on the iteration count i.
E(K_{FX}(i, Kᵢ), M H(I_{FX}(i, Kᵢ), Nᵢ₊₁ kᵢ₊₁ T_{RSP} Mᵢ F_{EX}(i, Kᵢ))

Trent appends the encrypted hash to the encrypted response parameters with the appended new public identifier Nᵢ₊₁ and sends the result to Alice.
A→T: Nᵢ₊₁E(kᵢ, kᵢ₊₁ T_{RSP}) E(K_{FX}(i, Kᵢ), Mᵢ H(I_{FX}(i, Kᵢ), Nᵢ₊₁ kᵢ₊₁ T_{RSP} Mᵢ F_{EX}(i, Kᵢ)))

Upon receiving the response from Trent, Alice obtains the new public identifier Nᵢ₊₁ and decrypts the remaining portion of the response in order to obtain the new white data key kᵢ₊₁, the response parameters T_{RSP}, the mutation value Mᵢ, and the hash. Alice can verify the new public identifier Nᵢ₊₁, the new white data key kᵢ₊₁, the response parameters T_{RSP}, and the mutation value Mᵢ by generating her own version of the hash and comparing her version of the hash to the hash included in the response from Trent.

Alice and Trent use the mutation value Mᵢ to independently generate a new or mutated large secret key Kᵢ₊₁. As described above, Alice and Trent can use a mutation function F_{M} to generate a new large secret key Kᵢ₊₁ based on the iteration count i, the mutation value Mᵢ randomly-generated by Trent, the current large secret key Kᵢ, and/or the number of bits returned by the hash function H.

As illustrated in the above messages, the requests and responses include a similar layout and each include an identifier (e.g., Nᵢ or Nᵢ₊₁), encrypted white data (e.g., E(kᵢ, T_{REQ}) or E(kᵢ, kᵢ₊₁ T_{RSP})), and encrypted black data including a message authentication code or hash (e.g., E(K_{FX}(i, Kᵢ), H( . . . )) or E(K_{FX}(i, Kᵢ), Mᵢ H(. . . ))). It should be understood that the white data (e.g., T_{REQ}, T_{RSP}, and kᵢ₊₁) could be also be transmitted as plaintext rather than being encrypted with the white data key kᵢ.

It should be understood that the above orderings and groupings of the request and response formats are for purpose of example only and can be varied.

Using the above request and response formats, Alice and Bob can exchange various types of requests and responses where only the request and response parameters are changed. Further specific examples of the message protocol therefore are expressed using the following abbreviated representation:
A→T: BCP_{REQ}(T_{REQ})
T→A: BCP_{RSP}(T_{RSP})

In some embodiments, the request and response parameters include command request codes that identify a message as a particular type of request or response. For example, assume that Trent assigns Alice the following randomly-generated initial command codes.
μᵢ=“Mutate Mutating ID” command code
αᵢ=“Get Encryption Key” command code
δᵢ=“Get Decryption Key” command code

Each command code can be the same length as encryption keys provided by Trent. Each command code mutates or is changed after each use.

Since the request and response parameters can include different types of data having different lengths, the above message protocol can use randomly-generated padding values (a “PAD” to ensure that all requests are the same size and all responses are the same size. By making sure that each request or response is the same size, an eavesdropper cannot determine the type of a request or a response based strictly on the number of bits it includes.

Using the above command codes and padding values, to generate a “Mutate Mutating ID” request, Alice generates a request for Trent with the following exemplary form:
A→T: BCP_{REQ}(μᵢ PAD[X])

were PAD[A] is Xbits of random padding.

In response, Trent generates a response for Alice with the following exemplary form:
A→T: BCP_{RSP}(XOR(μᵢ, μᵢ₊₁) PAD[A])

As a result of the above response from Trent, Alice's public identifier Nᵢ, secret white data key kᵢ, and large secret key Kᵢ have been mutated. In addition, the “Mutated Mutating ID” command code μᵢ has been mutated.

Using the above command codes and padding values, Alice can generate a “Get Encryption Key” request for Trent using the following exemplary form:
A→T: BCP_{REQ}(αᵢ PAD[A])

In response, Trent generates a response for Alice with the following exemplary form:
A→T: BCP_{RSP}(XOR(αᵢ, αᵢ₊₁) N_{RSP} E(K_{FX2}(i, Kᵢ), K_{RSP}) PAD[X])

where K_{RSP} is a randomly-generated encryption key and N_{RSP} is a randomly generated identifier associated with the encryption key K_{RSP}. The encryption key K_{RSP} is encrypted with Alice's large secret key Kᵢ or a portion thereof. For example, in some variants, the encryption key K_{RSP} is encrypted with the result of a key function K_{FX2}. The key function K_{FX2} can be different than the key function K_{FX} used in the other portions of the response from Trent and can include an irreversible function that generates a key based on the iteration count i and the large secret key Kᵢ. The key function K_{FX} is irreversible since, as described below, an eavesdropper could discover the encryption key K_{RSP} if Alice uses the encryption key to encrypt white or discoverable data. Using an irreversible function limits or prevents an eavesdropper from determining Alice's large secret key Kᵢ upon obtaining knowledge of the encryption key K_{RSP}. For example, the key function K_{FX2} can include a secure hash function that generates a hash of a portion of Alice's large secret key Kᵢ generated by an extraction function F_{EX2}, different from the extraction function F_{EX} described above, that extracts a portion of Alice's large secret key Kᵢ based on the iteration count i. The secure hash function included in the key function K_{FX2} can also generate a hash based on an initialization vector generated by an initialization function I_{FX2}, different from the initialization function described above. The initialization function I_{FX2} can generate an initialization vector based on the iteration count i and Alice's large secret key Kᵢ.

Since the requested encryption key K_{RSP} is encrypted with Alice's large secret key Kᵢ or a version thereof, the encrypted encryption key K_{RSP} does leak some information about Alice's large secret key Kᵢ. Similar to the information leaked by the message authentication code or hash described above, an attacker could use information contained in the encrypted encryption key K_{RSP} to rule out candidate keys when performing a brute-force attack. The amount of information leaked, however, in the encrypted encryption key K_{RSP}, can be accounted for in the calculation of when secret keys should be reset in order to substantially reduce or eliminate the possibility of a successful brute force attack. In some embodiments, the iteration count i is also incremented an additional count before being used in the key function K_{FX2} in order to further limit information leaked in the response.

As shown above in the response to the “Get Encryption Key” request, the encryption key K_{RSP} is included as part of the response parameters T_{RSP}, which are considered white data and encrypted with Alice's white data key kᵢ. The encryption key K_{RSP} is considered white data since it is likely that Alice will use the encryption key K_{RSP} to encrypt white data. If the encryption key K_{RSP} is used to encrypt white data, the encryption key K_{RSP} could potentially be discovered by an eavesdropper using a brute force attack. If the encryption key K_{RSP} were encrypted as black data with Alice's large secret key Kᵢ, an eavesdropper could use a discovered value of the encryption key to perform a brute force attack and determine information about Alice's large secret key Kᵢ and other black data exchanged between Alice and Trent. As described above, encrypting the encryption key K_{RSP} with a key generated by an irreversible function limits the ability of an eavesdropper to discover information about Alice's large secret key Kᵢ from obtained knowledge of the encryption key K_{SRP}. Therefore, by encrypting the encryption key K_{RSP} with Alice's white data key kᵢ, Alice's large secret key K_{A} and other black data exchanged between Alice and Trent are kept secure even if an eavesdropper is able to obtain the encryption key K_{RSP}.

Alice can use the above command codes and padding values to generate a “Get Decryption Key” request for Trent using the following exemplary form:
A→T: BCP_{REQ}(N_{REQ} δᵢ PAD[X])

where N_{REQ} is an identifier associated with the requested decryption key.

In response, Trent generates a response for Alice with the following exemplary form:
A→T: BCP_{RSP}(XOR(δᵢ, δᵢ′) E(K_{FX2}(i, Kᵢ), K_{RSP}) PAD[A])

where K_{RSP} is the requested decryption key associated with the identifier N_{REQ} provided in the request. As described above with respect to the “Get Encryption Key” request, the encryption key K_{RSP} can be encrypted with the result of a key function K_{FX2}, different than the key function K_{FX} used in the other portions of the response from Trent, that includes an irreversible function that generates a key based on the iteration count i and large secret key Kᵢ. As noted above, Trent can increment the iteration count i an additional count before using the count in the key function K_{FX2}.

As previously noted, entities can use the above request formats to request encryption and decryption keys from the authenticator. The entities use the encryption keys to encrypt data (e.g., digital content) before transmitting the data to other entities, and the entities receiving the encrypted data request the needed decryption keys from the authenticator. Using the authenticator as the key distributor allows the entities to communicate with each other without having to establish a separate encryption or session key between entities. Since neither entity is required to initiate a secure session with the other entity by sending plaintext or non-encrypted data to the other data (i.e., no handshaking is required), data transmitted between the entities can always be encrypted. Using this encryption strategy, the above request and response formats can be used to establish mutating transport layer security that can be applied to various applications, such as e-mail exchange, digital content management, secure file transfers, client-server sessions, etc.

Mutating Lock Box

In some embodiments, the mutating IDs held by an entity, such as an identification mutating ID, a digital signature mutating ID, a key pair mutating ID, a fingerprint mutating ID, and/or a large mutating ID are stored in a secure memory device, referred to as a mutating lock box. The data stored in the mutating lock box can be encrypted to reduce the effectiveness of offline brute force attacks. In some embodiments, the data stored in the mutating lock box is separately encrypted, as described above, such that black data and white data are not encrypted with the same keys. Activating or opening the mutating lock box can require multiple steps or factors. For example, an entity attempting to activate the mutating lock box may be required to provide a user password and/or a PIN. The authenticator device 28 may also perform multiple checks and analyses, such as performing a box identifier currency check and analyzing available system data. In some embodiments, the mutating lock box is stored in a hard drive or permanent memory device of an entity. In other embodiments, the mutating lock box is stored in a portable memory device, such as a universal serial bus (“USB”) Flash drive.

Various features of the invention are set forth in the following claims.

1. A method of encrypting data, the method comprising:
establishing first data including first discoverable data and first undiscoverable data;
establishing a first key and a second key, the second key being substantially underivable from the first key;
encrypting the first discoverable data with the first key; and
encrypting the first undiscoverable data with the second key

2. The method of claim 1 further comprising mutating at least one of the first key and the second key, establishing second data including second discoverable data and second undiscoverable data, encrypting the second discoverable data with the first key, and encrypting the second undiscoverable data with the second key.

3. The method of claim 1 further comprising establishing a third key.

4. The method of claim 3 wherein establishing a third key includes establishing a third key based on at least one of the first key and the second key.

5. The method of claim 3 wherein establishing a third key includes establishing a third key by performing an exclusive OR of a fourth key and at least one of the first key and the second key.

6. The method of claim 3 further comprising encrypting at least a portion of the discoverable data with the third key.

7. The method of claim 6 further comprising mutating the third key.

8. The method of claim 1 wherein encrypting the discoverable data with a first key includes encrypting the discoverable data and a result of encrypting the undiscoverable data with the second key with the first key.

9. The method of claim 1 wherein encrypting the undiscoverable data with a second key includes encrypting the undiscoverable data and a result of encrypting the discoverable data with the first key with the second key.

10. The method of claim 1 further comprising establishing an identifier.

11. The method of claim 10 further comprising appending the identifier to at least one of a result of encrypting the discoverable data with the first key and a result of encrypting the undiscoverable data with the second key.

12. The method of claim 11 further comprising mutating the identifier.

13. The method of claim 1 further comprising generating a hash of at least a portion of the data.

14. The method of claim 13 further comprising encrypting the hash with the second key.

15. A system for encrypting data including discoverable data and undiscoverable data, the system comprising:
a sender having a first key and a second key, the second key being substantially underivable from the first key, the sender configured to encrypt the discoverable data with the first key, to encrypt the undiscoverable data with the second key, and to receive at least one of a mutated first key and a mutated second key.

16. The system of claim 15 further comprising an authenticator configured to establish the first key and the second key.

17. The system of claim 16 wherein the authenticator is further configured to establish the mutated first key and the mutated second key.

18. The system of claim 15 wherein the sender further has a third key.

19. The system of claim 18 wherein the third key is based on at least one of the first key and the second key.

20. The system of claim 18 wherein the third key is based on the result of an exclusive OR of a fourth key and at least one of the first key and the second key.

21. The system of claim 18 wherein the sender is further configured to encrypt at least a portion of the discoverable data with the third key.

22. The system of claim 21 wherein the sender is further configured to receive a mutated third key.

23. The system of claim 15 wherein the sender is further configured to encrypt the discoverable data and a result of encrypting the undiscoverable data with a second key with the first key.

24. The system of claim 15 wherein the sender is further configured to encrypt the undiscoverable data and a result of encrypting the discoverable data with the first key with the second key.

25. The system of claim 15 wherein the sender further has an identifier.

26. The system of claim 25 wherein the sender is further configured to append the identifier to at least one of a result of encrypting the discoverable data with the first key and a result of encrypting the undiscoverable data with the second key.

27. The system of claim 26 wherein the sender is further configured to receive a mutated identifier.

28. The system of claim 15 wherein the sender is further configured to generate a hash of at least a portion of the discoverable data.

29. The system of claim 28 wherein the sender is further configured to encrypt the hash with the second key.

30. A storage device for storing data, the device configured to encrypt discoverable data with a first set of keys and undiscoverable data with a second set of keys, the second set of keys being substantially underivable from the first set of keys.

31. The storage device of claim 30 further configured to communicate with an authenticator to receive a mutation of at least one of the first set of keys or the second set of keys.

32. The storage device of claim 30 further configured to require authorization before activating.

33. The storage device of claim 32 wherein the authorization includes at least one of a password and a personal identification number.

34. A method of transmitting messages between an entity and an authenticator comprising:
establishing an identifier associated with the entity;
establishing a first key to encrypt only undiscoverable data, the first key known only to the entity and the authenticator;
establishing a second key to encrypt only discoverable data, the second key known only to the entity and the authenticator;
encrypting request parameters with the second key to create an encrypted request;
generating a hash of the request parameters;
encrypting the hash of the request parameters with the first key to create an encrypted request hash;
the entity sending the encrypted request and the encrypted request hash to the authenticator; and
mutating at least one of the first key and the second key.

35. The method of claim 34 wherein generating a hash of the request parameters includes generating a hash of the request parameters and the identifier.

36. The method of claim 35 further comprising appending the identifier to at least one of the encrypted message and the encrypted message hash.

37. The method of claim 36 further comprising establishing a key function that extracts a portion of the first key based on the identifier.

38. The method of claim 37 wherein encrypting the hash of the request parameters with the first key includes encrypting the hash of the request parameters with a result of the key function.

39. The method of claim 34 further comprising establishing an initialization vector based on the first key and the identifier.

40. The method of claim 39 wherein generating a hash of the request parameters includes generating a hash of the request parameters based on the initialization vector.

41. The method of claim 34 further comprising establishing an extraction function based on the first key and the identifier.

42. The method of claim 41 wherein generating a hash of the request parameters includes generating a hash of the request parameters and a result of the extraction function.

43. The method of claim 34 further comprising mutating the identifier to create a mutated identifier and sending the mutated identifier to the entity.

44. The method of claim 43 further comprising mutating the second key to create a mutated second key and encrypting the mutated second key and response parameters with the second key to create an encrypted response.

45. The method of claim 44 further comprising the generating a random mutation value.

46. The method of claim 45 wherein mutating at least one of the first key and the second key includes mutating at least one of the first key and the second key using the mutation value.

47. The method of claim 46 further comprising generating a hash of the mutated identifier, the mutated second key, the mutation value, and the response parameters.

48. The method of claim 47 wherein generating a hash of the mutated identifier, the mutated second key, the mutation value, and the response parameters includes generating a hash of the mutated identifier, the mutated second key, the mutation value, and the response parameters based on an initialization vector.

49. The method of claim 48 wherein generating a hash of the mutated identifier, the mutated second key, the mutation value, and the response parameters includes generating a hash of the mutated identifier, the mutated second key, the mutation value, the response parameters, and a result of the extraction function.

50. The method of claim 49 further comprising encrypting the mutation value and the hash of the mutated identifier, the mutated second key, the mutation value, and the response parameters with the first key to create an encrypted response hash.

51. The method of claim 50 wherein encrypting the mutation value and the hash of the mutated identifier, the mutated second key, the mutation value, and the response parameters with the first key includes encrypting the mutation value and the hash of the mutated identifier, the mutated second key, the mutation value, and the response parameters with a result of a key function.

52. The method of claim 51 further comprising appending the mutated identifier to at least one of the encrypted response and the encrypted response hash.

53. The method of claim 52 further comprising sending the encrypted response and the encrypted response hash to the entity.
